(19) United States
(12) Patent Application Publication
(10) Pub. No.: US 2022/0197698 A1
(43) Pub. Date: Jun. 23, 2022

(54) SYSTEM AND METHODS FOR SUBDIVIDING AN UNKNOWN LIST FOR EXECUTION OF OPERATIONS BY MULTIPLE COMPUTE ENGINES

(71) Applicant: KOMPRISE INC., CAMPBELL, CA (US)

(72) Inventors: MICHAEL PEERCY, CAMPBELL, CA (US); RANJANA BHADORIA, CAMPBELL, CA (US); SANJOG SINHA, BANGALORE (IN); PRATEEK KANSAL, BANGALORE (IN)

(21) Appl. No.: 17/558,943

(22) Filed: Dec. 22, 2021

Related U.S. Application Data
(60) Provisional application No. 63/129,892, filed on Dec. 23, 2020.

(51) Int. Cl. G06F 9/50

(52) U.S. Cl. CPC G06F 9/505; G06F 2209/5017

(57) ABSTRACT

An electronic system for subdividing an unknown list of objects in an object store for execution of operations on the objects therein uses a plurality of computer engines. Each computer engine has a processor, a memory coupled to the processor and the memory storing program instructions. The program instructions when executed by a processor of a first of the computer engines, causes the processor of a first computer engine to: partition the multidimensional metadata space of an object store into a set of mutually exclusive tasks; and deliver the set of mutually exclusive tasks to a plurality of different computer engines for processing.

### RELATED APPLICATIONS

This patent application is related to U.S. Provisional Application No. 63/129,892 filed Dec. 23, 2020, entitled “SYSTEM AND METHODS FOR SUBDIVIDING AN UNKNOWN LIST FOR EXECUTION OF OPERATIONS BY MULTIPLE COMPUTE ENGINES” in the name of the same inventors, and which is incorporated herein by reference in its entirety. The present patent application claims the benefit under 35 U.S.C § 119(e).

### TECHNICAL FIELD

The present application generally relates to object stores, and, more particularly, to useful operations on the metadata and data of files in file storage systems and objects in object storage systems where those files and objects exist in an ordered list of files or objects.

### BACKGROUND

Frequently in operations such as copying all objects from one object store to another, the amount of data to transfer is great while the time allowed is small. A single computer engine—for example, and without limitation, a thread, a collection of threads, a process, a collection of processes, or a standalone computer—may not be able to do all the work quickly enough. In this case one may need to employ parallel processing across multiple computer engines.

The hardest case of computer engines to employ in parallel may be separate computers that do not share memory or disk because the specific work they are assigned may need to be communicated to them. If the quantum of work is too small, the time taken for that communication could overwhelm the time taken to actually do the operation on the assigned work. If the quantum of work is too large, then all but one computer could have finished their assigned work while the entire task is not complete because one computer is still working on its larger assigned work.

If the work—hereafter known as a task—can be subdivided in advance, it can be assigned as subtasks of similar size to the separate computers. However, it may be likely that the structure and size of the data to be worked on is unknown and that it therefore may not be able to be subdivided in advance. In particular, the contents of an object store may be discovered only as the list is traversed from the beginning to the end in a single threaded manner. The data may need to be subdivided on the fly. This subdivision should be effective and tolerant of all sorts of data structures that are encountered. In other words, it should be dynamic and not static.

Furthermore, because the work must be sent to another computer, the work cannot be subdivided into too small quanta or the subdivisions may be inefficient. The work should be sent in the largest amounts possible in order to be maximally efficient.

Current state of the art solves this problem by determining the structure and size of subtasks in a prior step. However, that generally requires time and space and adds complexity to the total effort.

Therefore, it would be desirable to provide a system and method that overcome the above problems. The system and method would be able to determine a structure and size of subtasks in a prior step without the required time and space and added complexity of prior art systems and methods. The system and method, without loss of generality, will apply to files and directories in a file server just as it applies to objects and prefixes in an object store. Hence prefix can be used to mean prefix or directory and object can be used to mean object or file. While the present invention in its present application is designed for separate computers, it can be applied in the case of separate computer engines of any type, including, without limitation, threads, collections of threads, processes, collections of processes, services, and collections of services.

### SUMMARY

In accordance with one embodiment, an electronic system for subdividing an unknown list of objects in an object store for execution of operations on the objects therein using a plurality of computer engines is disclosed. Each computer engine has a processor, a memory coupled to the processor and the memory storing program instructions. The program instructions when executed by a processor of a first of the computer engines, causes the processor of a first computer engine to: partition the multidimensional metadata space of an object store into a set of mutually exclusive tasks; and deliver the set of mutually exclusive tasks to a plurality of different computer engines for processing.

### BRIEF DESCRIPTION OF THE DRAWINGS

The present application is further detailed with respect to the following drawings. These figures are not intended to limit the scope of the present application but rather illustrate certain attributes thereof.

FIG. 1 is a diagram of an exemplary system for subdividing an unknown list for execution of operations by multiple computer engines according to one aspect of the present application;

FIG. 2 is a simplified block diagram of an exemplary embodiment of a computing device/server depicted in FIG. 1 in accordance with one aspect of the present application;

FIG. 3 is a diagram of an exemplary system for subdividing an unknown list for execution of operations by multiple computer engines according to one aspect of the present application; and

FIG. 4 is a diagram of an exemplary subdivision of work by hash on object name according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure may be constructed and/or utilized. The description sets forth the functions and the sequence of steps for constructing and operating the disclosure in connection with the illustrated embodiments. It is to be understood, however, that the same or equivalent functions and sequences may be accomplished by different embodiments that are also intended to be encompassed within the spirit and scope of this disclosure.

Specific embodiments of the invention may now be described in detail with reference to the accompanying figures. Like elements in the various figures may be denoted by like reference numerals for consistency.

In the following detailed description of embodiments of the invention, numerous specific details may be set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more novel electronic file and object analysis and management systems and methods of operating such novel systems. These descriptions and representations are the means used by those experienced or skilled in the art to most effectively convey the substance of their work to others skilled in the art.

Reference herein to “one embodiment” or “an embodiment” may mean that a particular feature, structure, or characteristic described in connection with the embodiment can be included in at least one embodiment of the invention. The appearances of the phrase “in one embodiment” in various places in the specification are not necessarily all referring to the same embodiment.

Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

Moreover, for the purpose of describing the invention, an “electronic system,” a “computing unit,” and/or a “main computing unit” are each defined as electronic-circuit hardware device, such as a computer system, a computer server, a data storage unit, or another electronic-circuit hardware unit controlled, managed, and maintained by a file migration module, which is executed in a CPU and a memory unit of the electronic-circuit hardware device for the electronic file migration management.

In addition, for the purpose of describing the invention, a term “computer server” is defined as a physical computer system, another hardware device, a software and/or hardware module executed in an electronic device, or a combination thereof. For example, in context of an embodiment of the invention, a “computer server” is dedicated to executing one or more computer programs for executing and maintaining a robust and efficient file and object management system among varieties of storage systems. Furthermore, in one embodiment of the invention, a computer server is connected to one or more data networks, such as a local area network (LAN), a wide area network (WAN), a cellular network, and the Internet.

Without loss of generality, the terms for files and objects can be considered interchangeable, and the terms for file systems and object stores can be considered interchangeable. Because a preferred embodiment of this invention is specific to the list objects operation on object stores, the description of embodiments will focus on objects in object stores. However, embodiments of the invention can handle files in file stores to the extent that the file store provides a similar ordered list and the operations being performed are not dependent on the directory being handled before its contained subdirectories and files.

The present disclosure relates to systems and methods for subdividing an unknown list for execution of operations by multiple computer engines. The system and methods may list objects in order on separate computer engines using common object store mechanisms, divide the lists into tasks using information from the objects in the list, and handle those tasks on the separate computer engines. The system and method may capture requests to subdivide the tasks into a number of smaller subtasks and handle those subtasks on separate computer engines. The system and method may divide the lists into tasks and subtasks using a hash on each object name to distribute the work evenly and without bias from any characteristic of the object name or object. The system and method may divide the list into tasks and subtasks using a hash on each object prefix name to distribute the work evenly by prefix so all objects within each prefix may be handled by the same computer engine. The system and method may divide the list into tasks and subtasks using a hash on each object prefix name to distribute the work by a first phase that handles prefixes only, then divides the list into tasks and subtasks using a hash on each object name to distribute the work in a second phase that handles objects only, then again divides the list by prefix to distribute the work in a third phase that handles prefixes only again. The system and method may divide the lists into tasks and subtasks using size of each object or alternatively, or in addition to, using the most recent create, modify, or access time of each object.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

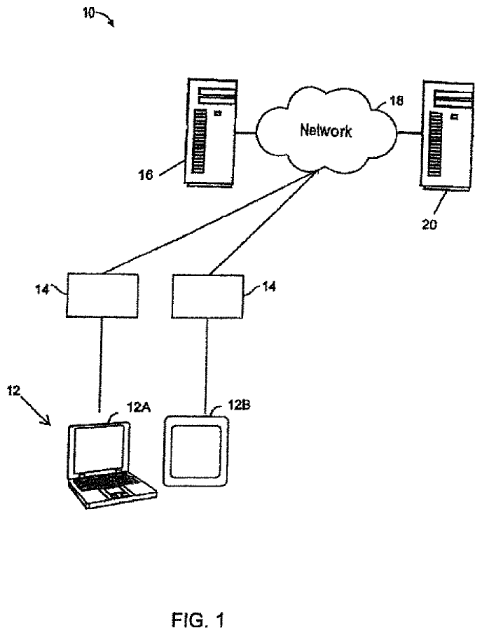

Referring to FIG. 1, a system 10 for subdividing an unknown list for execution by multiple computer engines may be seen. The components of the system 10 may be coupled through wired or wireless connections.

The system may have one or more computing devices 12. The computing devices 12 may be a client computer system such as a desktop computer, handheld or laptop device, tablet, mobile phone device, server computer system, multiprocessor system, microprocessor-based system, network PCs, and distributed cloud computing environments that include any of the above systems or devices, and the like. The computing device 12 may be described in the general context of computer system executable instructions, such as program modules, being executed by a computer system as may be described below. In the embodiment shown in FIG. 1, the computing device 12 may be seen as a desktop/laptop computing system 12A and a tablet device 12B. However, this should not be seen in a limiting manner as any computing device 12 described above may be used.

The computing devices 12 may be loaded with an operating system 14. The operating system 14 of the computing device 12 may manage hardware and software resources of the computing device 12 and provide common services for computer programs running on the computing device 12.

The computing devices 12 may be coupled to one or more server(s) 16/20. The server(s) 16/20 may be used to store data files, programs and the like for use by the computing devices 12. The computing devices 12 may be connected to the server(s) 16/20 through a network 18. The network 18 may be a local area network (LAN), a general wide area network (WAN), wireless local area network (WLAN) and/or a public network. In accordance with one embodiment, the computing devices 12 may be connected to the server(s) 16/20 through a network 18 which may be a LAN through wired or wireless connections. Similarly, in accordance with one embodiment, the server 16 may be connected to the server 20 through the network 18 which may be a WAN through wired or wireless connections.

In accordance with one embodiment, the servers 20 may be used for migration and data back-up. The server 20 may be any data storage devices/system. In accordance with one embodiment, the server 20 may be cloud data storage. Cloud data storage is a model of data storage in which the digital data is stored in logical pools, the physical storage may span multiple servers (and often locations), and the physical environment is typically owned and managed by a third-party hosting company. However, as defined above, cloud data storage may be any type of data storage device/system.

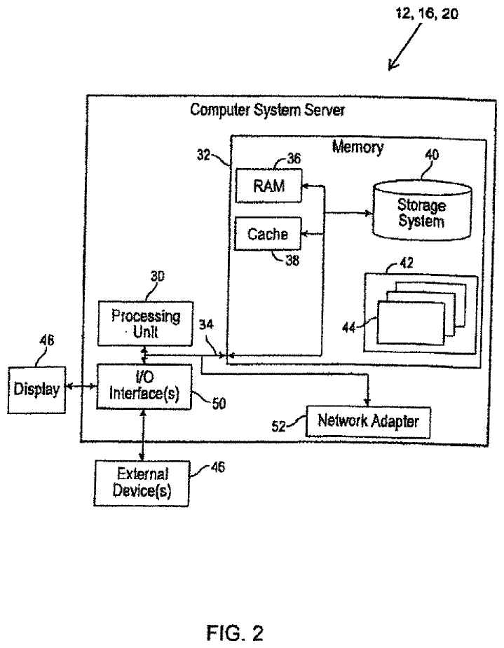

Referring now to FIG. 2, the computing devices 12 and/or servers 16, 20 may be described in more detail in terms of the machine elements that provide functionality to the systems and methods disclosed herein. The components of the computing devices 12 and/or servers 16, 20 may include, but are not limited to, one or more processors or processing units 30, a system memory 32, and a system bus 34 that couples various system components including the system memory 32 to the processor 30. The computing devices 12 and/or servers 16, 20 may typically include a variety of computer system readable media. Such media may be chosen from any available media, including non-transitory, volatile and non-volatile media, removable and non-removable media. The system memory 32 could include one or more personal computing system readable media in the form of volatile memory, such as a random-access memory (RAM) 36 and/or a cache memory 38. By way of example only, a storage system 40 may be provided for reading from and writing to a non-removable, non-volatile magnetic media device typically called a “hard drive”.

The system memory 32 may include at least one program product/utility 42 having a set (e.g., at least one) of program modules 44 that may be configured to carry out the functions of embodiments of the invention. The program modules 44 may include, but is not limited to, an operating system, one or more application programs, other program modules, and program data. Each of the operating systems, one or more application programs, other program modules, and program data or some combination thereof, may include an implementation of a networking environment. The program modules 44 generally carry out the functions and/or methodologies of embodiments of the invention as described herein.

The computing device 12 and/or servers 16, 20 may communicate with one or more external devices 46 such as a keyboard, a pointing device, a display 48, or any similar devices (e.g., network card, modern, etc.). The display 48 may be a Light Emitting Diode (LED) display, Liquid Crystal Display (LCD) display, Cathode Ray Tube (CRT) display and similar display devices. The external devices 46 may enable the computing devices 12 and/or servers 16, 20 to communicate with other devices. Such communication may occur via Input/Output (I/O) interfaces 50. Alternatively, the computing devices and/or servers 18, 20 may communicate with one or more networks 18 such as a local area network (LAN), a general wide area network (WAN), and/or a public network via a network adapter 52. As depicted, the network adapter 52 may communicate with the other components of the computing device 18 via the bus 34.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any combination of one or more computer readable media (for example, storage system 40) may be utilized. In the context of this disclosure, a computer readable storage medium may be any tangible or non-transitory medium that can contain, or store a program (for example, the program product 42) for use by or in connection with an instruction execution system, apparatus, or device. A computer readable storage medium may be, for example, but not limited to, an electronic, magnetic, optical, electromagnetic, infrared, or semiconductor system, apparatus, or device, or any suitable combination of the foregoing.

One aspect of an embodiment of the present invention is providing an electronic file handling system 10 and a related method of operation that divides unknown lists of objects or files into mutually exclusive lists of tasks in order to assign the tasks to separate computers 12.

File and object storage systems are organized in discrete units such as file system shares or object store buckets. If the size of these is small and the number is large, work to be performed on them can be distributed across computers 12 by simply distributing the shares or buckets across the computers 12. However, if the size of the shares or buckets is large, or if the number of the shares or buckets is small, or if the variance in the size of the shares or buckets is high, distributing them across the computers 12 will generally not result in the most efficient distribution of the total work. In these cases, dividing each share or bucket and distributing the subdivisions will result in a more efficient distribution of the work and a quicker time to completion of the total work on a particular set of compute engines.

Without loss of generality, one can consider a single large object store bucket composed of objects. The same aspects of the embodiments of the present invention apply to a single large file system share composed of directories and files and any number of any size of buckets and shares.

An object store bucket comprises a set of objects, each with its own name. If the structure of the object names is not known in advance, it is not possible to evenly subdivide the object store listing in advance among an arbitrary number of compute engines. This embodiment of the present invention subdivides the object store listing while discovering it.

In this embodiment of the present invention, the list of all objects in the object store may be recognized as an unknown sorted list. As the list is traversed from the beginning, certain objects may become known, as does certain metadata of the objects. This metadata may offer a mechanism to subdivide the unknown sorted list of objects into interleaved sublists. In this embodiment, these unknown sublists may be assigned to tasks that are distributed among separate compute engines.

Each element of each sublist may be an object. By construction of the subdivision, each object may be unique and may appear in only one sublist. The sublists may therefore be mutually exclusive and can be assigned to separate computers 12 without conflict. However, the sublists may not be necessarily mutually ordered, and therefore operations that require prefix or postfix handling of prefixes cannot necessarily be satisfied by the subdivisions of work unless those subdivisions are prefix-aware.

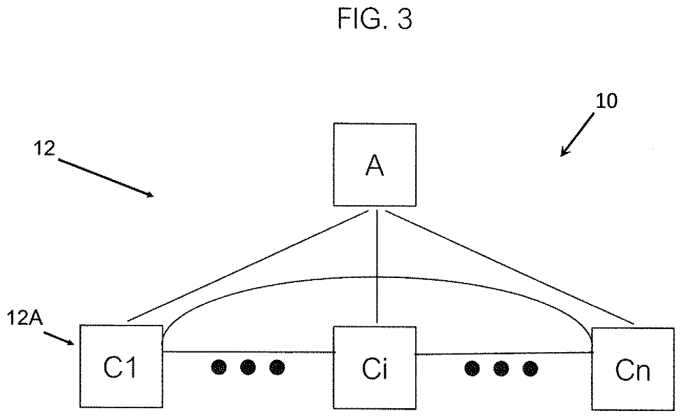

FIG. 3 shows an example of the system 10 having a plurality of computers 12. The computers 12 labeled C1 . . . Ci . . . Cn may be worker computers 12A while the computer 12 labeled A may be collecting the results of the work for recording and disposition. In this embodiment the computer 12 labeled A assigns one sublist of the complete list of objects to each of the worker computers 12A labeled C1 through Cn. The worker computers 12A labeled C1 through Cn each may enumerate the complete list of objects and may test each object against the specification of the sublist assigned to it. When an object matches the specification of the computer's sublist, the worker computer 12A may operate on that object. Those objects that do not match the specification may be ignored. Each worker computer 12A may report its respective progress through the complete list and results from the assigned sublist to the computer 12 labeled A. Hence the entire list of objects may be operated on in a completely distributed manner by the full complement of independent worker computers 12A.

In accordance with one embodiment, the work performed by each worker computer 12A may differ in duration and therefore one of the worker computers 12A may complete its assigned sublist before the other worker computers 12A. In this case the newly idle worker computer 12A who has finished with their assigned task, for example, without loss of generality the worker computer 12A labeled C1, may notify the computer 12 labeled A that it is idle and could perform more work.

Each worker computers 12A may periodically update the computer 12 labeled A with the progress each has made through the complete list of objects and its assigned sublist. The computer 12 labeled A may select the worker computer 12A that reports the greatest amount of work as yet unperformed. In this example, without loss of generality, let that be the worker computer 12 labeled C2. Computer 12 labeled A may subdivide the sublist assigned to the worker computer 12A labeled C2 into two new sublists, and assign the specification of one sublist to another worker computer 12A. For example, the computer 12 labeled A may assign the specification of one sublist to the worker computer 12A labeled C1, and inform the worker compute 12A labeled C2 of the specification of its new smaller sublist.

As other worker computers 12A with assigned tasks, for example the worker computer 12A labeled Ci, finish with their respective assigned tasks, the compute 12 labeled A may recognize that one or more of the worker computers 12A may have finished their assigned tasks. For example, if the worker computer 12A labeled Ci has finished its assigned task, the computer 12 labeled A may request that the worker computer 12A that has reported the largest list of available work subdivide that list and return a sublist to assign to the completing worker computer 12 engine, i.e. worker computer 12 labeled Ci, and communicates that sublist to the worker computer 12A labeled Ci. This process may continue until the entire list of objects is discovered and dynamically subdivided among the compute engines and all operations on the objects are finished.

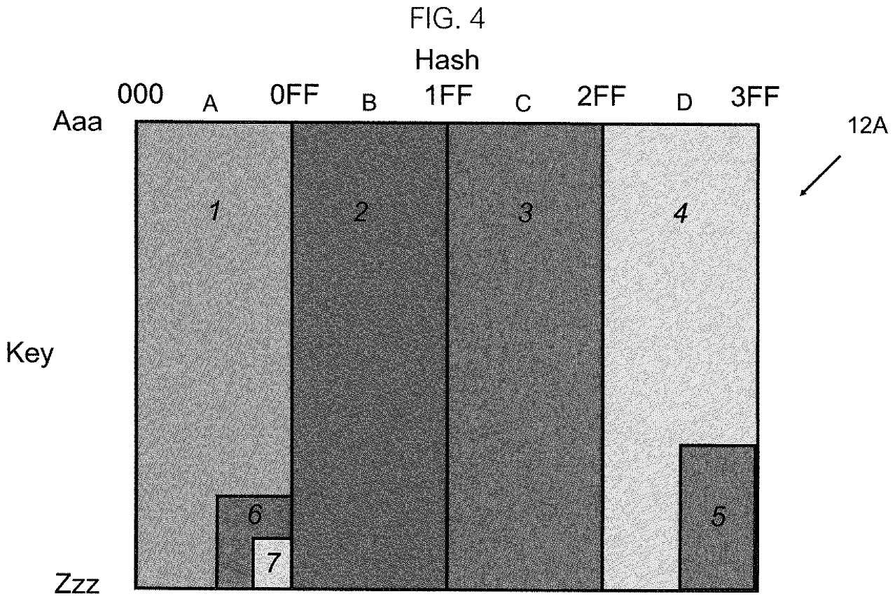

An example of a computer 12 that may use a subdivision function to subdivide a list into sublists may be seen in FIG. 4. The computer 12 may use a subdivision function to subdivide a list into sublists and assign as subtasks to four worker computers 12A labeled as A, B, C, D, that initially take the first four subtask assignments 1, 2, 3, and 4. In the example of FIG. 4, worker computer 12 labeled C finishes with assignment 3 first.

In this example, the subtask assignment 4 (null, 300-3FF) may be the furthest from done, so the computer 12 (FIG. 3) may ask the worker computer 12A labeled D to split that subtask assignment 4. The worker computer 12A labeled D may give back subtask 5 (“Qqq”, 380-3FF), which the director computer 12 may assign to worker computer 12A labeled C. Next, the worker computer 12A labeled B may finish with subtask 2 (null, 0FF-1FF) and the computer 12 may ask the worker computer 12A labeled A to split its subtask. The worker computer 12A labeled A may split subtask 1 and return subtask 6 (“Uuu”,080-0FF), which the computer 12 may assign to worker computer 12 labeled B. If the worker computer 12 labeled D finishes more quickly since half its remaining work was taken by worker computer 12A labeled C, the worker computer 12A labeled C may ask the computer 12 for more work. The computer 12 may ask the worker computer 12A labeled B to subdivide its subtask, which the worker computer 12A labeled B does by returning subtask 7 (“Www”,0C0-0FF). The director computer 12 may assign this subtask to worker computer 12A labeled D. This process may continue until the entire list of objects is discovered and dynamically subdivided among the compute engines and all operations on the objects are finished.

It should be noted that the number of sublists could be much larger than the number of worker computers 12A. In this situation, each worker computer 12A may be assigned a number of sublists at the beginning. Subdivision of sublists assigned to a worker computer 12A in this case is by subdividing the set of sublists assigned to the worker computer 12A rather than subdividing the single assigned sublist itself.

In accordance with one embodiment, the communication for subdividing sublists could also occur entirely among the worker computers 12A (i.e., worker computers 12A labeled A, B, C, and D) without involving the computer 12.

Another aspect of an embodiment of the present invention may divide the lists into tasks and subtasks using a hash on each object name to distribute the work evenly and without bias from any characteristic of the object name or object. The specification of the sublist sent to each worker computer 12A may then be a hashing function that subdivides the list into some number of sublists and what part or parts of the hashing function may be allocated to the worker computer 12.

FIG. 4 shows the example list divided into tasks and subtasks based on a hash on each object name, which may generate an initially even subdivision of work. As the actual work in this example becomes uneven over time, further subdivisions may also be done on the same hash on each object name.

Another aspect of an embodiment of the present invention divides the list into tasks and subtasks using a hash on each object prefix name to distribute the work evenly by prefix so all objects within each prefix may be handled by the same worker computer 12A. This may allow the contents of prefixes to be handled in an ordered way so prefix operations could precede the objects within the prefix and prefix operations could succeed the objects within the prefix.

Another aspect of an embodiment of the present invention divides the list in phases. For example, the list may be divided into tasks and subtasks using a hash on each object prefix name to distribute the work by a first phase that handles prefixes only, then divides the list into tasks and subtasks using a hash on each object name to distribute the work in a second phase that handles objects only, then again divides the list by prefix to distribute the work in a third phase that handles prefixes only again. This may allow all preceding operations on a per-prefix basis to occur before any object content handling occurs and all succeeding operations on a per-prefix basis to occur after all object content handling occurs.

Another aspect of an embodiment of the present invention may divide the lists into tasks and subtasks using a size of each object. With this subdivision, the objects may be separated into smaller objects and larger objects, with as many bands of object size as desired. This may be useful if there are size-specific advantages in subdividing the objects.

Another aspect of an embodiment of the present invention may divide the lists into tasks and subtasks using the most recent create, modify, or access time of each object.

Another aspect of an embodiment of the present invention may divide the lists into tasks and subtasks using a combination of any or all of a hash on each object name, the size of each object, the most recent create, modify, or access time of each object, or any other characteristic of each object that can be determined while listing the objects.

Another aspect of an embodiment of the present invention may recognize differences in the amount of work to be done for each sublist and differences in the capability of each worker computer 12A and load balances the sublists among the worker computers 12A accordingly. Note that, depending on operation, this balancing should be cognizant of aspects in the sublists such as the number of objects and the size of objects and should be cognizant of aspects in the worker computer 12A such as the number of computer processors, the amount of memory, and the network bandwidth.

Another aspect of an embodiment of the present invention may balance the subtasks among the separate worker computers 12A by dividing the subtask into different types. For example, the subtask may be divided into two sets, one set to handle objects and one set to handle prefixes.

Another aspect of an embodiment of the present invention may balance the subtasks among the separate worker computers 12A unevenly by object size, distributing tasks with larger object sizes to worker computers 12A designed to handle operations on objects with larger size and distributing tasks with smaller object sizes to worker computers 12A designed to handle operations on objects with smaller size.

Another aspect of an embodiment of the present invention may divides the work into many more subtasks than worker computers 12A and orders the subtasks by priority, still guaranteeing that each subtask is mutually exclusive. When a worker computer 12A finishes with its subtask, it requests another subtask and is assigned the next subtask from a reservoir of as-yet-unassigned subtasks in priority order.

This embodiment may allow stripes of work based on the dimension of the subdivision function of the original list to be assigned to the worker computer 12A so higher priority sublists of the whole list may be completed before lower priority sublists. In accordance with one embodiment of the present invention, and without loss of generality, this may allow objects with more recent access, modify, or create time to be operated on before objects with less recent access, modify, or create time. Also, without loss of generality, the next subtask from the reservoir of subtasks could be assigned to a worker computer 12A from the reservoir of subtasks randomly or uniformly without regard to priority at all. In another embodiment of the present invention, the reservoir of subtasks may be held centrally or it may be distributed among the several worker computers 12A in advance and redistributed as each worker computer 12A complete the work on their current subtasks.

Another aspect of an embodiment of the present invention may distribute the sublists to the worker computers 12A in order to analyze the metadata of the objects. This aspect of this embodiment of the present invention may require that the means of subdividing the list be very efficient. In particular, since analysis of object metadata and discovery of prefixes and objects may often require the same operations on the object store, discovering the list in an earlier step and subdividing it in a later step is counterproductive. Subdividing the list efficiently is generally required.

Another aspect of an embodiment of the present invention may distribute the sublists to one or more of the worker computers 12A in order to analyze the data of the prefixes and objects through mechanisms such as reading in-object metadata or full-object indexing.

Another aspect of an embodiment of the present invention may distribute the sublists to one or more of the worker computers 12A in order to analyze the metadata and data of the prefixes and objects and store the results as per-object records in a database.

Another aspect of an embodiment of the present invention may distribute the sublists to one or more of the worker computers 12A in order to copy the prefixes and objects to another object store.

Another aspect of an embodiment of the present invention may distribute the sublists to one or more of the worker computers 12A in order to move the prefixes and objects to another object store.

Another aspect of an embodiment of the present invention may distribute the sublists to one or more of the worker computers 12A in order to delete the prefixes and objects.

Another aspect of an embodiment of the present invention may distribute the sublists to one or more of the worker computes 12A in order to move prefixes and objects and leave dynamic links in the style of U.S. Pat. No. 10,198,447.

Another aspect of an embodiment of the present invention may distribute the sublists to one or more of the worker computers 12A in order to perform an arbitrary operation typical for prefixes and objects on the directories and files in the sublists.

While embodiments of the disclosure have been described in terms of various specific embodiments, those skilled in the art will recognize that the embodiments of the disclosure may be practiced with modifications within the spirit and scope of the claims

What is claimed is:

1. An electronic system for subdividing an unknown list of objects in an object store for execution of operations on the objects therein comprising:
a plurality of computer engines, wherein each computer engine comprises:
a processor;
a memory coupled to the processor, the memory storing program instructions;
wherein the program instructions when executed by a processor of a first of the computer engines, causes the processor of a first computer engine to:
partition the multidimensional metadata space of an object store into a set of mutually exclusive tasks; and
deliver the set of mutually exclusive tasks to a plurality of different computer engines for processing.

2. The electronic system of claim 1, wherein the memory storing program instructions that when executed by the processor of the first computer engine, causes the processor of the first computer system to:
subdivide corresponding tasks of the set of mutually exclusive tasks into a plurality of subtasks, each of the plurality of subtasks being smaller in size than the corresponding tasks from which divided; and
deliver the plurality of subtasks to the plurality of different computer engines for processing.

3. The electronic system of claim 2, wherein the memory storing program instructions that when executed by the processor of the first computer engine, causes the processor of the first computer system to:
receive and record subtask progress reported by each of the different computer engines; and
receive a subtask completion notice from each completing computer engine when each of the completing computer engines finishes processing an assigned subtask.

4. The electronic system of claim 2, wherein the memory storing program instructions that when executed by a processor of a corresponding computer engine processing an assigned subtask, causes the processor of the corresponding computer engine processing the assigned subtask to partition the assigned subtask.

5. The electronic system of claim 2, wherein the memory storing program instructions that when executed by the processor of the first computer engine, causes the processor of the first computer engine to:
request a partitioning of a largest recorded subtask into additional subtasks from a corresponding computer engine processing the largest recorded subtask;
receive the additional subtasks of the largest recorded subtask; and
deliver the additional subtasks of the largest recorded subtask to separate available computer engines.

6. The electronic system of claim 2, wherein the memory storing program instructions that when executed by a processor of a computer engine processing a subtask, causes the processor of the computer engine processing the subtask to enumerate a list of objects in the object store and select objects from the list of objects that match the subtask being processed.

7. The electronic system of claim 6, wherein partitioning of the object store is determined by a hash on each object name in the list of objects.

8. The electronic system of claim 6, wherein partitioning of the object store is determined by a hash on each object prefix name in the list of objects.

9. The electronic system of claim 8, wherein the memory storing program instructions that when executed by the processor of the first computer engine, causes the processor of the first computer system to distribute the plurality of subtasks in phases with a phase before object handling and a phase after object handling that handle prefixes only.

10. The electronic system of claim 6, wherein partitioning of the object store is determined by a size of an object in the list of objects.

11. The electronic system of claim 6, wherein partitioning of the object store is determined by one of a create, modify, or access time of an object in the list of objects.

12. The electronic system of claim 2, wherein the memory storing program instructions that when executed by the processor of the first computer engine, causes the processor of the first computer system to load balance distribution of the subtasks across the plurality of computer engines.

13. The electronic system of claim 8, wherein each object prefix name is distributed to a subset of the plurality of computer engines.

14. The electronic system of claim 2, wherein the memory storing program instructions that when executed by the processor of the first computer engine, causes the processor of the first computer system to load balance distribution of the subtasks across the plurality of computer engines based on monitored capabilities.

15. The electronic system of claim 6, wherein the memory storing program instructions that when executed by the processor of the first computer engine, causes the processor of the first computer system to prioritize distribution of the plurality of subtasks based on characteristics of the objects in each subtask as they relate to the partition of all objects across all subtasks.

16. The electronic system of claim 2, wherein the memory storing program instructions that when executed by the processor of the first computer engine, causes the processor of the first computer system to distribute the plurality of subtasks to analyze metadata and data of the objects in the object store.

17. The electronic system of claim 16, wherein the memory storing program instructions that when executed by the processor of the first computer engine, causes the processor of the first computer system to store data of the analysis.

18. The electronic system of claim 2, wherein the memory storing program instructions that when executed by the processor of the first computer engine, causes the processor of the first computer system to deliver the plurality of subtasks to the plurality of different computer engines to copy prefixes and objects to another object store.

19. The electronic system of claim 2, wherein the memory storing program instructions that when executed by the processor of the first computer engine, causes the processor of the first computer system to deliver the plurality of subtasks to the plurality of different computer engines to move prefixes and objects to another object store.

20. The electronic system of claim 2, wherein the memory storing program instructions that when executed by the processor of the first computer engine, causes the processor of the first computer system to deliver the plurality of subtasks to the plurality of different computer engines to delete prefixes and objects.

21. The electronic system of claim 2, wherein the memory storing program instructions that when executed by the processor of the first computer engine, causes the processor of the first computer system to deliver the plurality of subtasks to the plurality of different computer engines to move prefixes and objects and leave a dynamic link associated with each prefix and object moved.
